(19) United States
(12) Patent Application Publication
(10) Pub. No.: US 2009/0272030 A1
(43) Pub. Date: Nov. 5, 2009

(54) GREENHOUSE LIGHTING

(75) Inventors: Teunis Cornelis van den Dool, Monster (NL); John Wiegel, Monster (NL)

Correspondence Address: TROUTMAN SANDERS LLP;BANK OF AMERICA PLAZA, 600 PEACHTREE STREET, N.E., SUITE 5200, ATLANTA, GA, 30308-2216, US

(73) Assignee: Hortilux Schreder B.V., Monsier (NL)

(21) Appl. No.: 11/718,128

(22) PCT Filed: Oct. 17, 2005
(86) PCT No.: PCT/NL05/00746

§ 371 Date: Jan. 9, 2008

(30) Foreign Application Priority Data
Oct. 29, 2004 (NL) 1027379
Oct. 29, 2004 (NL) 1027381
Jun. 23, 2005 (NL) 1029324

(51) Int. Cl. A01G 9/14; F21V 19/00; A01G 9/20

(52) U.S. Cl. 47/17; 362/382

(57) ABSTRACT

The invention relates to a greenhouse lighting fitting that is in particular suitable for use in combination with an assimilation lamp. The greenhouse lighting fitting has a fitting body which comprises a fastening element for mechanically fastening the greenhouse lighting fitting to a part of a bearing structure, a reflector for directing the light emanating from a lamp fitted in the greenhouse lighting fitting downwards and a contact member for making an electrical connection with a lamp fitted in the greenhouse lighting fitting.

The greenhouse lighting fitting according to the invention is characterized by the fact that the greenhouse lighting fitting furthermore has a support for bearing a lamp, which support is provided with a primary positioning element for positioning a lamp resting on the support relative to the greenhouse lighting fitting, and which support is moveable relative to the fitting body between a first position in which a lamp can be placed on the support and a second position in which the position of the support relative to the fitting body ensures that a lamp resting on the support is mechanically secured relative to the fitting body.

According to a first aspect, the invention relates to a greenhouse lighting fitting, in particular suitable for use in combination with an assimilation lamp, which greenhouse lighting fitting has a fitting body which comprises a fastening element for mechanically fastening the greenhouse lighting fitting to a part of a bearing structure, a reflector for directing the light emanating from a lamp fitted in the greenhouse lighting fitting downwards and a contact member for making an electrical connection with a lamp fitted in the greenhouse lighting fitting.

The Applicant is familiar with greenhouse lighting fittings of the abovementioned type which use lamps with a screw fitting.

It is an object of the first aspect of the invention to provide an improved greenhouse lighting fitting.

This object is achieved by the invention by a greenhouse lighting fitting according to claim 1.

The greenhouse lighting fitting according to the first aspect of the invention enables quick fitting of the lamp in the fitting as the lamp does not have to be secured separately with respect to the support. It is sufficient to place the lamp on the support when this support is in its first position, the lamp being positioned by the primary positioning element. By moving the support, together with the lamp positioned thereon, into its second position, the lamp is automatically secured in the greenhouse lighting fitting.

This makes it possible to place the lamp in the fitting by means of a swift and reliable operation. This is particularly advantageous since, when lamps are being fitted in greenhouse lighting fittings, the fitter usually has to work overhead and the fittings in existing greenhouses are difficult to access because of the plants situated under greenhouse lighting fittings. In addition, with the greenhouse lighting fitting according to the invention, the lamp automatically ends up straight in the fitting.

It is advantageous if the greenhouse lighting fitting is designed in such a manner that the contact member bears against a contact element of the lamp under a suitable contact pressure in the second position of the support in order to produce the electrical connection with the lamp. Thus, the electrical connection of the lamp no longer requires a separate operation.

In a mechanically advantageous embodiment, the fitting body comprises a first spring element, which is designed to mechanically secure a lamp resting on the support with respect to the fitting body when the support is in its second position. The friction force caused by the spring force effectively keeps the lamp in place. Alternatively or in addition, the support may comprise a second spring element, which is designed to mechanically secure a lamp resting on the support with respect to the fitting body when the support is in its second position. Such a spring element can be produced in a simple manner by means of a leaf spring.

An advantageous way from the point of view of design to ensure that the contact member of the greenhouse lighting fitting presses against a contact element of a lamp resting on a support under a suitable contact pressure is the use of a third spring element which presses the contact member of the greenhouse lighting fitting against the contact element of the lamp when the support is in its second position. The presence of a separate spring element for the contact member makes it possible to optimize the contact pressure, independently of the spring force which the first and/or second spring element have to provide in order to secure a lamp situated in the support. After all, the spring stiffness of the third element can be selected independently from the spring stiffness of the other spring elements.

In order to facilitate the installation of a lamp in the greenhouse lighting fitting according to the invention, the support advantageously has a handle, with which the support can be moved from its first position into its second position and from its second position into its first position.

The support may be fastened to the fitting body so as to be translatable, but it is also possible for the support to have a pivot point, about which pivot point the support can swing relative to the fitting body. In the latter case, it is advantageous if the handle is situated further away from the pivot point than the primary positioning element. As a result of the lever action, the support can be moved from its first into its second position with relatively little force, while the lamp resting on the support is nevertheless clamped firmly.

Provision is made for the fitting body also to comprise a secondary positioning element which is designed to cooperate, in the second position of the support, with the primary positioning element of the support in order to position a lamp resting on the support relative to the fitting body. In order to prevent static overdetermination, it is advantageous if the primary positioning element positions the lamp in a first direction and the secondary positioning element positions the lamp in a second direction, the first and the second direction being different from one another.

Advantageously, the first and/or the third spring element is arranged in the secondary positioning element. Incidentally, the first and/or the third spring element can also be arranged in a counter-element which does not have a positioning function per se.

The greenhouse lighting fitting according to the invention is particularly suitable for use in combination with what is referred to as a double-ended lamp, that is to say a lamp with two ends, each end having a fastening surface and each end usually also having a contact element. A greenhouse lighting fitting according to the invention which is suitable for use in combination with such a lamp advantageously has a primary positioning element which comprises two positioning elements arranged at a distance from one another, each of which is designed to engage on the fastening surface of the lamp.

It is common for double-ended lamps to be provided with a pinch in the glass on at least one of the two ends. A greenhouse lighting fitting which is suitable for use in combination with such lamps preferably has a primary positioning element which is designed to engage on this pinch.

In practice, it has been found that a double-ended lamp, the pinch of which has a substantially H-shaped cross section, is a good choice for use in a greenhouse lighting fitting according to the invention. A greenhouse lighting fitting according to the invention which is suitable for use in combination with such a lamp preferably has a primary positioning element in the shape of a block which fits into the pinch of the lamp.

In order to prevent the support from moving from its second position into its first position in an uncontrolled manner, it is advantageous if the support comprises a lock for locking the support in its second position.

The first aspect of the invention also relates to a method for fitting a lamp in a greenhouse lighting fitting according to the invention, which method successively comprises the following steps:
moving the support into its first position,
placing a lamp on the primary positioning element, the lamp being positioned relative to the greenhouse lighting fitting,
moving the support into its second position, the lamp being secured relative to the fitting body.

Furthermore, the first aspect of the invention relates to a combination of an assimilation lamp and a greenhouse lighting fitting according to the invention and to a greenhouse provided with at least one greenhouse lighting fitting according to the invention.

According to a second aspect, the invention relates to a greenhouse lighting fitting with a fitting body which comprises at least one lamp holder and one reflector, a connecting unit for producing an electrical connection of the greenhouse lighting fitting, a fastening element for mechanically fastening the greenhouse lighting fitting to a bearing structure provided in the greenhouse, as well as a lamp gear for operating a lamp mounted in the greenhouse lighting fitting, which lamp gear can be electrically connected to the connecting unit.

NL 7613233 describes a lighting installation for propagating houses. The known lighting installation comprises a plurality of greenhouse lighting fittings which are each suspended from a heating pipe by means of a bearing frame, said heating pipe extending horizontally through the greenhouse. The individual greenhouse lighting fittings each comprise a connecting unit for electrically connecting the greenhouse lighting fitting to an external power source and a fitting body having at least one lamp holder and one reflector. With the known lighting installation, the connecting unit of each greenhouse lighting fitting has a power inlet and a power outlet.

The first greenhouse lighting fitting of a group of associated greenhouse lighting fittings is connected to an external power source, for example the mains, via the power inlet. A power cable having a plug at both ends then connects the power outlet of the first greenhouse lighting fitting to the power inlet of the next greenhouse lighting fitting of the group.

A drawback of the known greenhouse lighting fitting is that it is difficult to mount in a greenhouse, particularly because the individual greenhouse lighting fittings are awkward to handle, for example because they are relatively large and heavy.

It is an object of the second aspect of the invention to provide an improved greenhouse lighting fitting and an improved method for fastening a greenhouse lighting fitting in a greenhouse.

This object is achieved by the second aspect of the invention through the greenhouse lighting fitting according to claim 36 and the method according to claim 47.

With the greenhouse lighting fitting according to the second aspect of the invention, the preassembly unit, on the one hand, and the fitting body, on the other hand, are designed to be detachable from one another.

This is highly advantageous with regard to installation, as thus the connecting unit of each greenhouse lighting fitting can first be connected to the electrical terminal without the entire greenhouse lighting fitting having to be handled and suspended from the bearing structure at the same time.

An advantage of electrically connecting the connecting unit while the fitting body is not yet connected thereto, is that the preassembly unit of which the connecting unit forms part is easy to handle while the electrical connection is being made using a power supply cable which can be connected to an external power source, such as the mains. This is important as the fitter generally has to work overhead when fitting the greenhouse lighting fittings.

In addition, connecting the greenhouse lighting fitting to a power supply cable involves quite a number of operations, in particular if the connection is made by means of a union nut. A connection of this type, which is advantageous with regard to moisture tightness and is therefore often preferred, is easier for the fitter to make when the connection can be made to a relatively light and small preassembly unit rather than to an already completely assembled greenhouse lighting fitting, which may weigh more than 10 kilograms.

It is customary for a bearing structure to be present in a greenhouse in order to fasten greenhouse lighting fittings thereto, which bearing structure comprises one or more horizontal girders which extend above the level of the plants. Power supply cables are preferably arranged on or in these girders in order to connect the greenhouse lighting fittings to an external power supply, such as the mains. Each power supply cable comprises at least one terminal for connecting a greenhouse lighting fitting.

Such a terminal may be produced in a variety of ways. A terminal may be in the form of ends of conductors of a power supply cable or of a tapping of this power supply cable, which ends have been stripped of their insulation. These ends are then guided into the preassembly unit via a union nut and connected there to the connecting unit.

Alternatively, the terminal may be in the form of a plug which, optionally via an intermediate cable having a second female socket and a second plug, can be connected to a female socket which forms part of the connecting unit. The plug may be attached to an end of the power supply cable or a tapping thereof. The plug may also be part of a splitter in the power supply cable.

In order to facilitate the fastening of the fitting body to the preassembly unit as much as possible, it is advantageous to design the electrical connection between the fitting body and the connecting unit in the form of a plug connection.

Because of the weight of the fitting body and in order to prevent it from falling, it is advantageous if a separate mechanical fastening for the fitting body is provided. This can be achieved by means of a second fastening element which secures the fitting body to the bearing structure or to the fastening element of the connecting unit. Alternatively, the fitting body can be connected mechanically to the connecting unit using the preassembly unit. It is also possible to use these variants in combination.

Preferably, any mechanical connection between the fitting body and the preassembly unit is designed without any screw connections, since this facilitates mounting. In addition, from the point of view of safety, the mechanical fastening of the fitting is preferably designed as a positive-locking connection, in particular in the vertical direction, as this is fail safe and the fitting body cannot fall down, even if any locking during the assembly which may or may not be required has been forgotten or not taken place yet.

The preassembly unit is preferably connected to the bearing structure by means of a fastening element before the fitting body is connected to the connecting unit. In this manner, the suspension point of the fitting body relative to the bearing structure is fixed.

When suspended, known greenhouse lighting fittings are often askew as a result of the resistance of the power supply cable to its deformation caused by the connection. By securing the preassembly unit relative to the bearing structure prior to the fitting of the fitting body, the fastening point of the greenhouse lighting fitting is fixed, as a result of which this undesired oblique position is prevented as the fastening of the preassembly unit offers resistance to the force exerted by the cable. Thus, it is no longer necessary to align the greenhouse lighting fittings after mounting or it is at least limited.

The greenhouse lighting fitting according to the second aspect of the invention comprises a lamp gear. Such a lamp gear may be composed of electronic components, but may also be electrical in form. Relative to the rest of the greenhouse lighting fitting, the lamp gear in particular is a heavy component. It is thus also advantageous to accommodate the lamp gear in the fitting body, especially when the lamp gear used is an electric ballast.

Modern horticultural greenhouses contain large numbers of greenhouse lighting fittings. One greenhouse lighting fitting per five linear meters is no exception. Supplying the assimilation lamps used in the greenhouse lighting fittings with power requires large amounts of electricity. In order to reduce the power consumption, it is advantageous to use three-phase power. In this case, preferably about one third of the greenhouse lighting fittings are connected to the first phase, about one third to the second phase and about one third to the third phase.

In order to make this solution possible, according to a second aspect of the invention, the greenhouse lighting fitting is preferably provided with a selection means which makes it possible to select the phase. This selection means is preferably arranged in the preassembly unit, so that the fitter who electrically connects the connecting unit to the external power source can set the desired phase at the same time. Preferably, the greenhouse lighting fitting in this embodiment is also provided with an indicator which indicates which phase has been selected, for example by means of a colour, figure or letter.

Below, greenhouse lighting fittings according to the various aspects of the invention will be described in more detail with reference to the attached drawing, which shows non-limiting exemplary embodiments, in which:

FIG. 1—shows an overview of a greenhouse lighting fitting according to the first aspect of the invention,

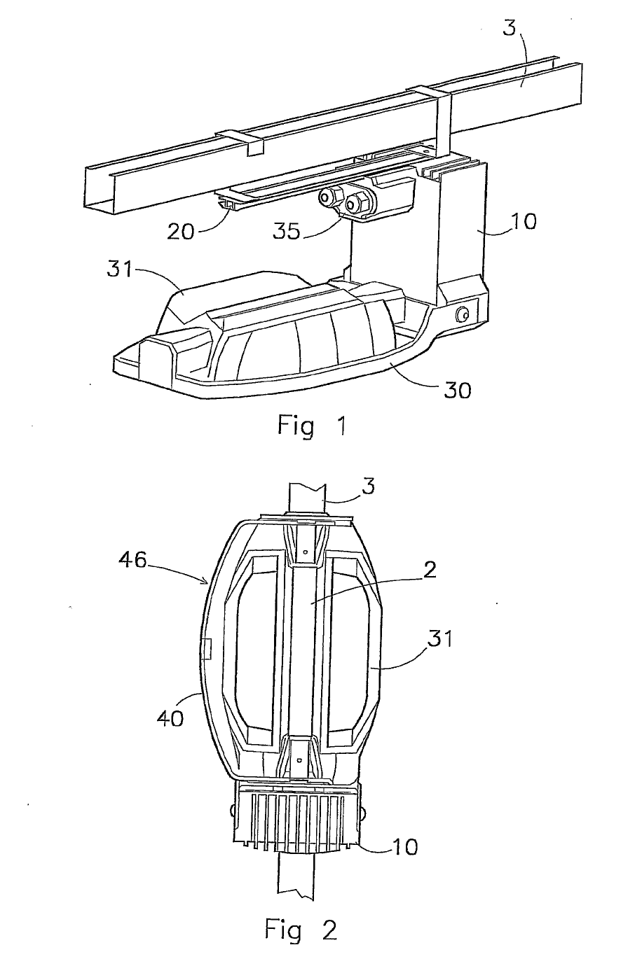

FIG. 2—shows a bottom view of a greenhouse lighting fitting from FIG. 1 with a lamp incorporated therein,

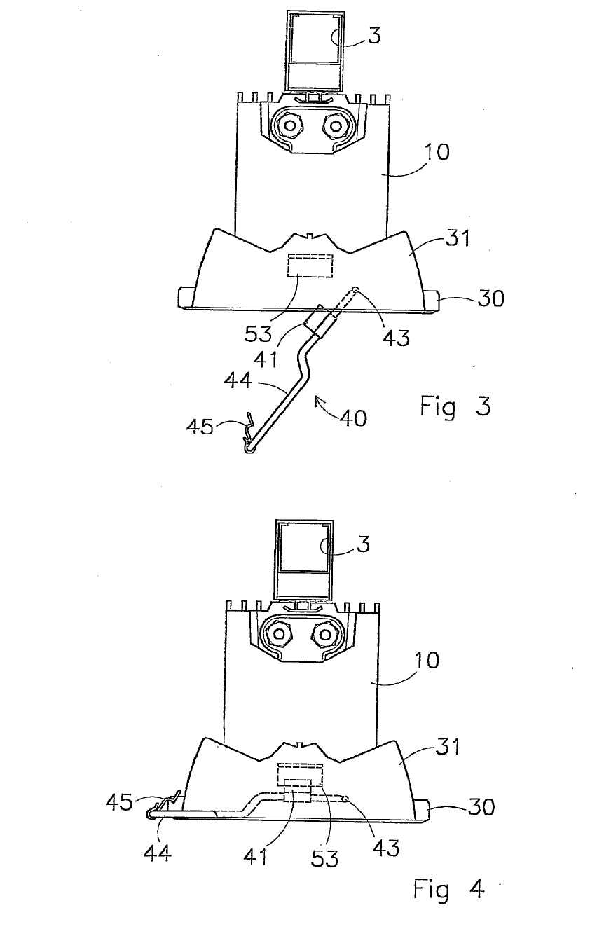

FIG. 3—shows a greenhouse lighting fitting from FIG. 1 with the support in the first position,

FIG. 4—shows a greenhouse lighting fitting from FIG. 1 with the support in the second position,

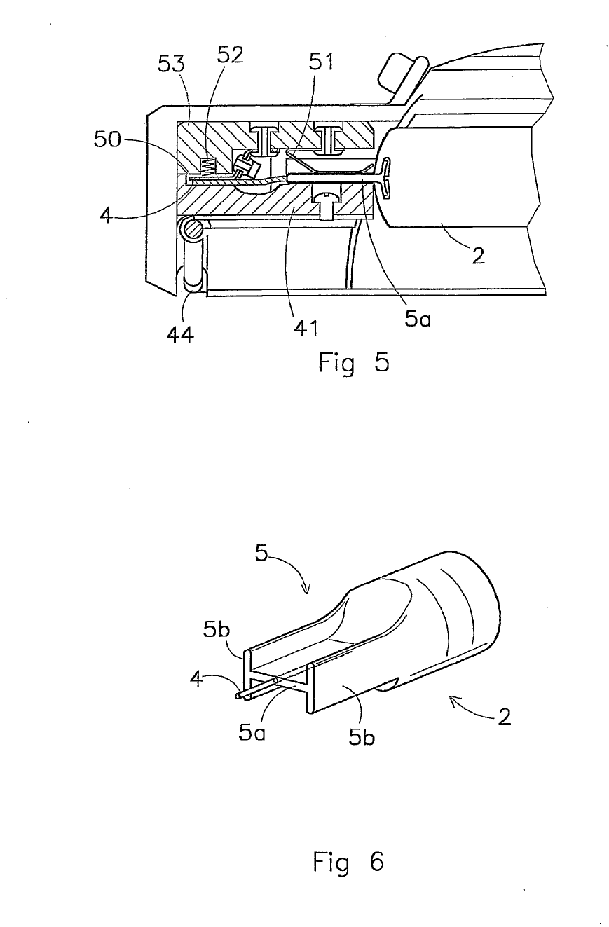

FIG. 5—shows a detail of the fastening of the lamp with the support in the second position, in cross section,

FIG. 6—shows a detail of an assimilation lamp,

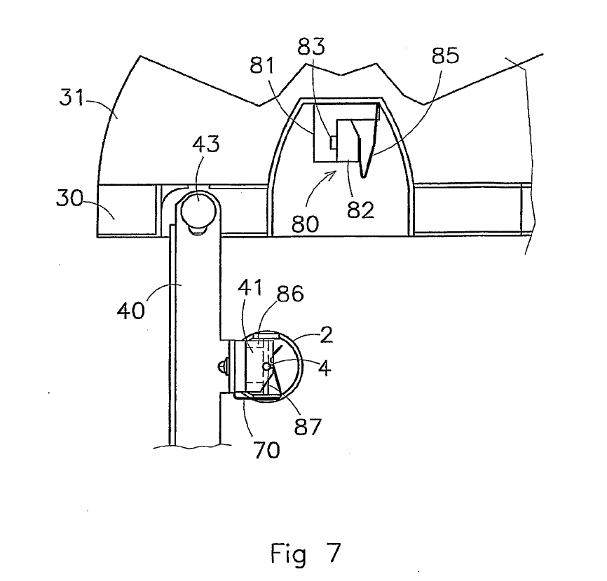

FIG. 7—shows a detail of an alternative embodiment according to the first aspect of the invention, with the support in the first position,

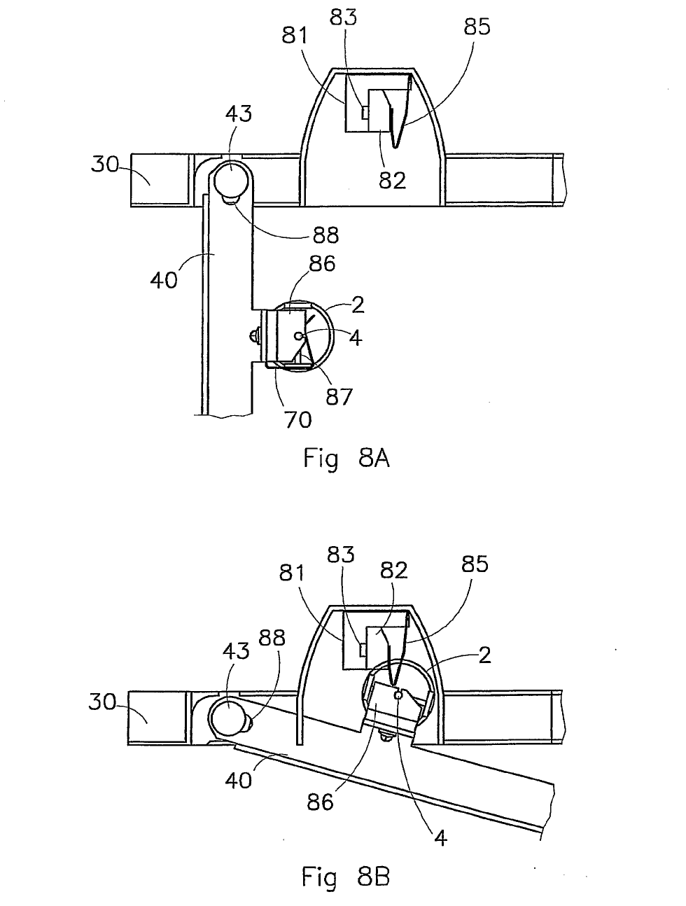

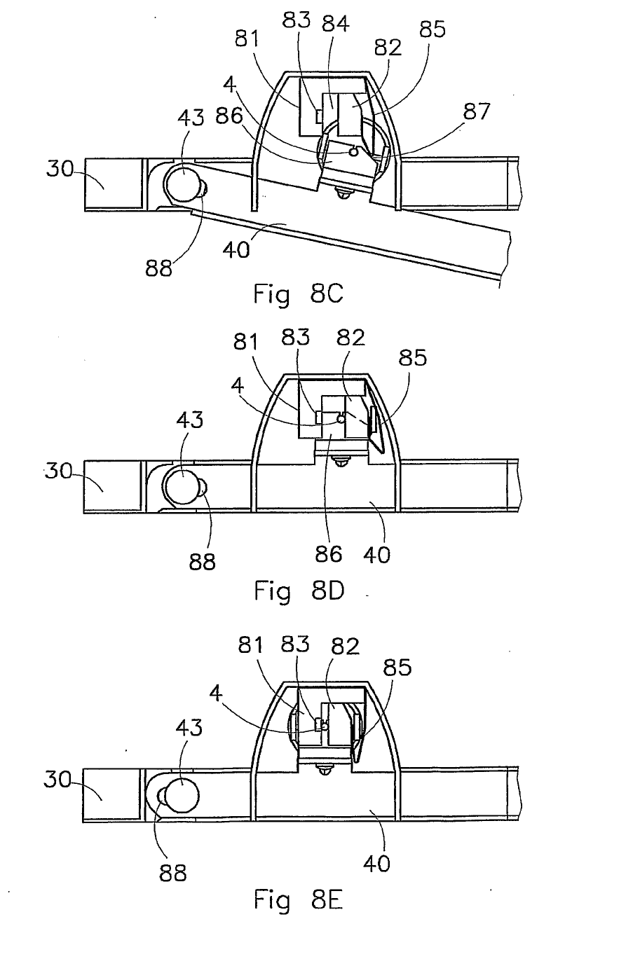

FIG. 8—shows moving the support from the first position to the second position with the embodiment of FIG. 7,

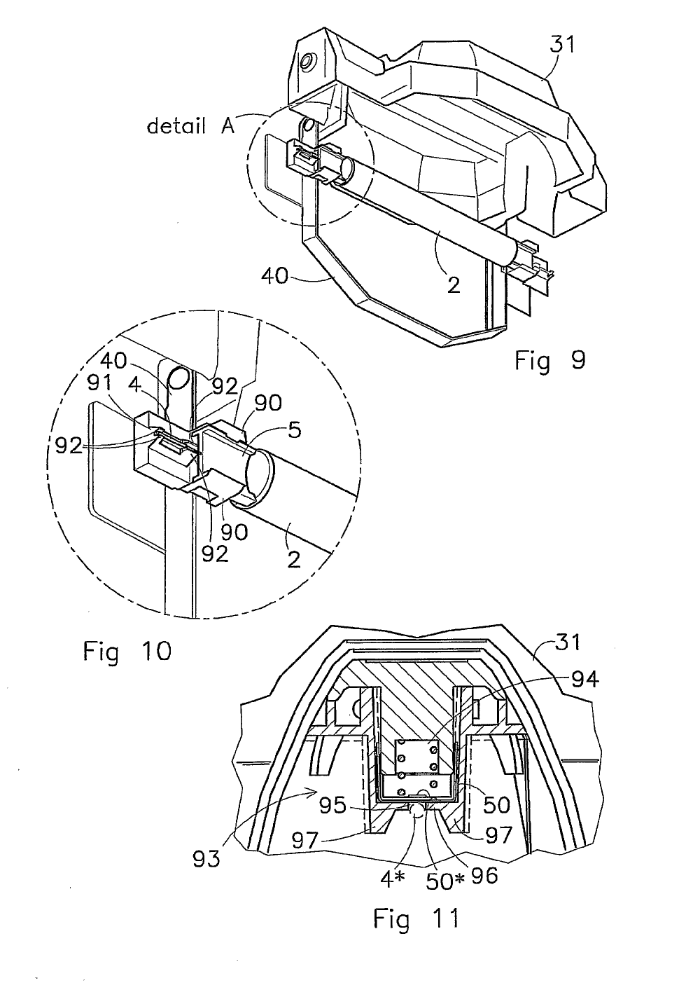

FIG. 9—shows a further alternative embodiment of a greenhouse lighting fitting according to the first aspect of the invention,

FIG. 10—shows an enlargement of detail A of FIG. 9,

FIG. 11—shows the connecting assembly 93 of the embodiment of the invention from FIG. 9,

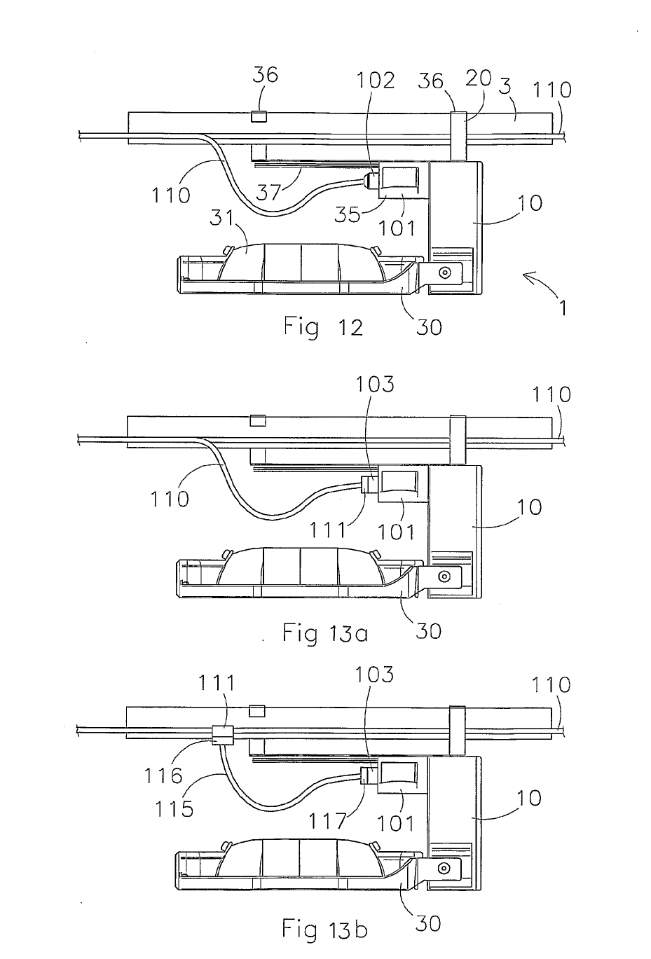

FIG. 12—shows an example of a greenhouse lighting fitting according to the second aspect of the invention,

FIG. 13—shows two further variants of the connection of the connecting unit to the power supply cable in a greenhouse lighting fitting according to the second aspect of the invention,

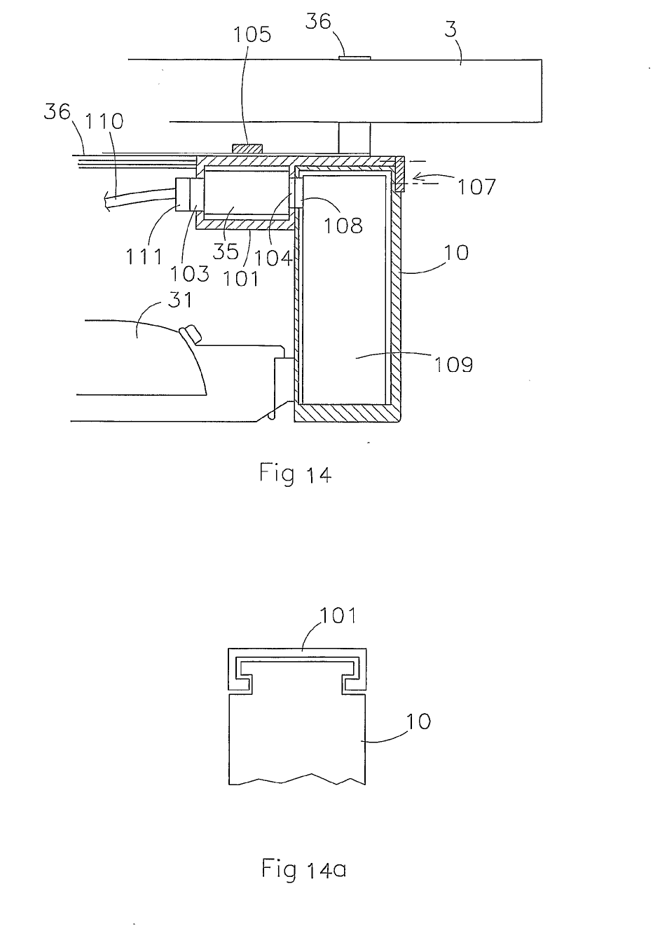

FIG. 14—shows a cross section of a part of a greenhouse lighting fitting according to the second aspect of the invention,

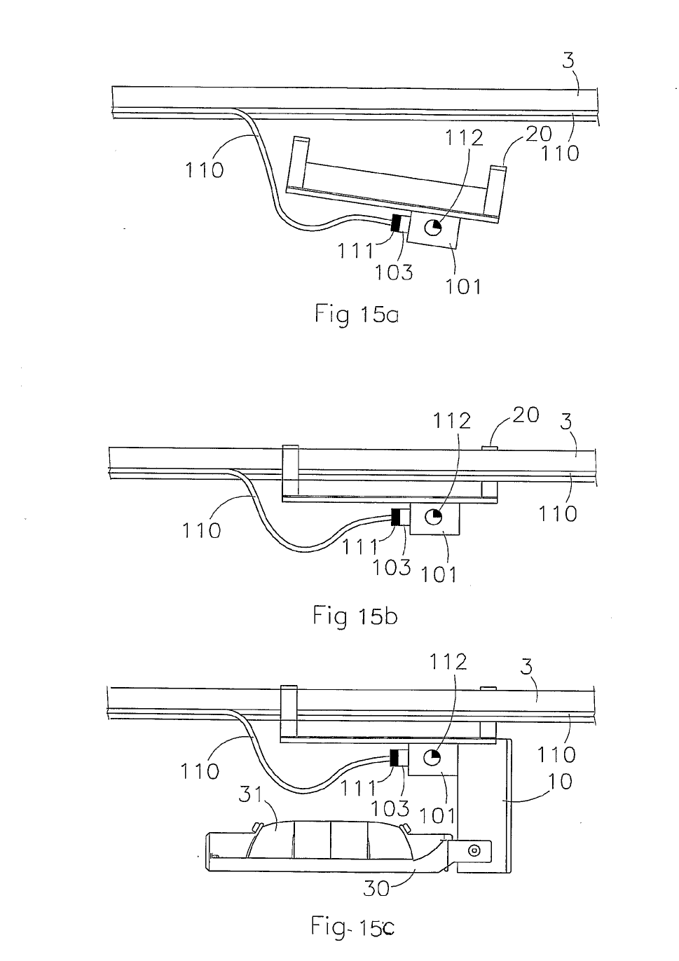

FIG. 15—shows an example of a method for fastening a greenhouse lighting fitting according to the second aspect of the invention in a greenhouse.

FIG. 1 shows an overview of a greenhouse lighting fitting according to the invention. Profiled section 3 forms part of a bearing structure to which the greenhouse lighting fitting is attached. The greenhouse lighting fitting is attached to the bearing structure by means of a fastening element 20.

The greenhouse lighting fitting according to the invention comprises a fitting body which, in the example of FIG. 1, comprises the fastening element 20, a connecting unit 35 for electrically connecting a lamp 2 in the fitting to an external power supply, an electronic lamp gear for operating a lamp 2 arranged in the fitting, a housing 10 for the lamp gear, a reflector 31 for directing light emitted by a lamp 2 placed in the greenhouse lighting fitting onto the plants, and a bracket 30 to which the reflector 31 is attached.

FIG. 2 shows a bottom view of the greenhouse lighting fitting of FIG. 1. In addition to the fitting body, a support 40 can now be seen which is designed to support a lamp 2. The support 40 does not form part of the fitting body, but is connected to the latter. The support 40 can be moved relative to the fitting body.

The support 40 has a primary positioning element which positions a lamp 2 supported by the support 40 relative to the greenhouse lighting fitting. In the example, the primary positioning element is designed such that a lamp 2, when it is placed on the primary positioning element, is at the same time also correctly positioned.

This is for example achieved by using a double-ended lamp 2 which is provided with a pinch 5 in the glass at both ends, which pinch gives one end of the lamp 2 an H-shaped cross section (see FIG. 6) with a central body 5a and two side bodies 5b.

In order to be able to position a lamp 2 of this type directly, the primary positioning element in this example has two positioning elements 41 arranged at a distance from one another. These positioning elements 41 are in the shape of blocks which fit into the H-shaped pinch of the lamp 2.

The support 40, including the primary positioning element, can be moved between a first position (see FIG. 3) and a second position (see FIG. 4). In this example, the support 40 is pivotable relative to the fitting body. Alternatively, the support 40 may be designed to be translatable, for example with a guide block on both sides of the fitting body, it being possible to move a rod of the support 40 through each block.

In the first position, a lamp 2 can be installed on the support 40 or be removed from the support 40. In the second position, the lamp 2 is mechanically secured relative to the fitting body.

FIG. 5 shows a detail of the fitting of the lamp 2 with the support 40 in the second position in cross section. The lamp 2 rests on the support 40, the positioning element 41 engaging on the pinch 5 of the lamp 2. The positioning element 41 is attached to a bracket 44 which, like the positioning element 41, forms part of the support 40. The positioning element 41 cooperates with a second positioning element which engages on a pinch on the other end of the lamp 2. Together, the positioning elements 41 position the lamp 2 relative to the fitting body. In this case, the positioning elements 41 are each designed as a block which fits into a pinch 5 of the lamp 2. Thus, the pinches 5 of the lamp 2 can only be placed on the positioning elements 41 of the support 40 in one way, as a result of which the lamp 2 is at the same time also correctly positioned relative to the fitting by just placing the pinches onto the positioning elements 41.

In this example, the fitting body comprises a first spring element 51 which engages on the pinch of the lamp 2 in the second position of the support 40. This first spring element pushes the lamp 2 against the positioning element 41 of the support 40 in the second position of the support 40, and thus mechanically secures the lamp 2 in the greenhouse lighting fitting. In this case, the first spring element 51 engages directly on the lamp 2. The lamp 2 is additionally secured against lateral movements relative to the fitting body by the raised edges of the H-shaped pinches.

In this example, the width of the leaf spring is chosen such that it contributes to the positioning of the lamp 2 relative to the fitting body by the fact that at least part of the leaf spring fits into the pinch of the lamp 2.

Alternatively or additionally, a second spring element (not shown) may be present, which forms part of the support 40. A second spring element of this type may be fitted between the bracket 44 of the support 40 and the positioning element 41. The second spring element could also be a leaf spring, the dimensions of which are chosen such that at least a part of the leaf spring fits into a pinch of the lamp 2 in such a manner that it positions the lamp 2. In this case, the positioning element 41 and the second spring element thus form a single entity.

In another alternative embodiment (not shown), the support 40 comprises a primary positioning element with a slot, into which the lamp 2 can be placed. The parts of the positioning element on either side of the slot are then moved towards one another in the second position of the support 40, so that the lamp 2 is securely clamped into the slot. This can be achieved, for example, by means of a resilient hinge, in which the two parts on both sides of the slot are pushed towards each other in the second position of the support 40 by the effect of a spring element.

In this example (see FIG. 6), the lamp 2 has a contact element 4 at each end for electrically connecting the lamp 2. This contact element 4 is designed in this example as a contact wire 4 protruding from the central body 5a of the H-shaped end 5, which wire 4 lies in the plane of the central body 5a, as it were.

The fitting body comprises a contact element 50 which comes to lie against a contact element 4 of the lamp 2 under a suitable contact pressure in order to produce the electrical connection of the lamp 2. In order to produce this contact pressure, a third spring element 52 is provided in this example, which acts on the contact element 50 of the fitting body.

The function of mechanically securing the lamp 2 in the greenhouse lighting fitting is in this example fulfilled by the first and/or second spring element, while the function of providing the contact pressure for the electrical connection of the lamp 2 is in this example fulfilled by the third spring element 52. By separating these functions, it is possible to optimize the spring force for mechanically securing the lamp 2 and the spring force for providing the contact pressure independently from one another. In concrete terms, this can be achieved by selecting the spring stiffness of the third element such that it differs from the spring stiffness of the first and/or second spring element. Thus, it is for example possible for the spring force which is exerted on the lamp 2 in the second position of the support 40 to be approximately 5 N, while the spring force which is simultaneously exerted on the contact element 4 of the lamp 2 is 50 N.

In the embodiment shown in the figures, the support 40 comprises a bracket 44, on which the positioning elements 41 are arranged. This bracket 44 is preferably provided with a handle 46, by which the fitter can hold on to the support 40 in order to change it from its first into its second position or vice versa. Incidentally, this handle may be produced by simply providing the bracket 44 with a free part which can serve as handle 46, as indicated in FIG. 2.

In the example of the figures, the support 40 has two pivot points 43, as a result of which the support 40 can pivot relative to the fitting body. In this case, it is advantageous if the handle lies further from the pivot points 43 than the positioning elements 41. By the lever action, the support 40 can be moved from its first into its second position with relatively little force, while the lamp 2 placed on the support 40 is still securely clamped.

In this example, the greenhouse lighting fitting furthermore has a lock 45 which locks the support 40 in its second position relative to the fitting body. The support 40 is thus secured in its second position.

Fitting a lamp 2 in the greenhouse lighting fitting of this example is carried out as follows:

The fitter brings the support 40 into its first position, for example in the downwardly directed position of FIG. 3. This uncovers the positioning element so that a lamp 2 can easily be placed on it. In the first position of the support 40, a lamp 2 thus placed on the positioning element still lies loosely on the support 40, although the positioning elements 41 keep the lamp 2 in position. However, the lamp 2 has not been secured in all its degrees of freedom.

Subsequently, the fitter moves the support 40 into its second position. The lamp 2 is then clamped between the positioning element and the fitting body, so that the lamp 2 is mechanically secured. At the same time, the contact member 50 of the greenhouse lighting fitting electrically contacts the contact element 4 (or the contact elements) of the lamp 2. This simultaneously provides the mechanical securing of the electrical connection of the lamp 2.

The fitter subsequently locks the support 40 using the lock 45, so that the support 40 is secured in its second position.

FIG. 7 shows a detail of an alternative embodiment with the support in the first position.

In this embodiment, the support is provided with a retaining means 70 which retains the lamp 2 relative to the positioning element 41 when the support is not in the second position. The retaining means 70 prevents the lamp 2 from falling out of the support 40 in this situation. In the example of FIG. 7, the retaining means 7C is a bent leaf spring which holds the lamp 2 against the positioning element 41.

It will be clear to those skilled in the art that a retaining means 70 may also be used with other embodiments of a greenhouse lighting fitting according to the invention.

The alternative embodiment of FIG. 7 has been designed such that there is no risk that the contact member in the fitting which provides the electrical connection with the lamp 2 can be touched inadvertently.

With the exemplary embodiment of FIG. 7, this is achieved by using a connecting assembly 80. This connecting assembly comprises a first connecting element 81 and a second connecting element 82. In the example of FIG. 7, the contact member 83 is provided in the first connecting element 81 in such a manner that the contact member 83 has a free surface which can contact the contact element 4 of the lamp 2 when the support 40 is in the second position. Alternatively, the contact member 83 may be provided in the second connecting element 82.

When the support 40 is in the first position, the connecting elements 81, 82 lie against one another. In this way, the contact member 83 is covered and cannot be touched inadvertently, thus virtually eliminating the risk of electric shock.

The connecting elements 81, 82 can be displaced relative to one another in such a manner that a space 84 can be created between the connecting elements. This space 84 is intended to accommodate the contact element 4 of the lamp 2. The contact element 4 of the lamp can be brought into contact with the contact member 83 of the greenhouse lighting fitting, thus electrically connecting the lamp 2.

If the contact element 4 is at least partly arranged in the space 84, the connecting elements 81, 82 are again moved towards one another. Preferably, the second connecting element 82 in this case pushes the contact element 4 of the lamp 2 against the contact member 83 of the greenhouse lighting fitting in order thus to provide the required contact pressure.

In the embodiment of FIG. 7, the second connecting element 82 is connected to the rest of the fitting body by means of a spring 85. This spring provides the required contact pressure.

In addition, in the example of FIG. 7, the support 40 is provided with a block 86 with a sloping side 87. The spring 85 is designed as a folded leaf spring in this example. The positioning of the block 86 and the spring 85 relative to one another is such that they engage on one another when the support 40 is moved from its first position to its second position. This is shown in FIG. 8.

FIG. 8A shows a part of the greenhouse lighting fitting from FIG. 7 with the support 40 in the first position. A lamp 2 is arranged on the positioning element 41 and is retained thereon by retaining means 70.

In the situation of FIG. 8B, the support 40 is pivoted about its pivot points 42 in the direction of the second position. The spring 85 is engaging with the block 86. For the sake of clarity, the retaining means 70 is not shown in FIG. 8B and following, although it is still always present.

In the situation of FIG. 8C, the support has been swivelled slightly more in the direction of the second position. The spring 85 engages with the sloping side 87 of the block 86 as a result of the angular displacement of the support 40 and thus of the block 86. Consequently, the spring 85 has been compressed, as a result of which the second connecting element 82 moves away from the first connecting element 81. Thus, a space 84 is created between the first connecting element 81 and the second connecting element 82, and the contact member 83 is thereby uncovered. As many components of the fitting body are in the vicinity of the free surface of the contact member 83 in this situation, the risk of someone inadvertently touching the contact member is virtually eliminated.

In the situation of FIG. 8D, the support has been swivelled slightly further still. The contact element 4 of the lamp 2 is now in the space 84 between the first connecting element 81 and the second connecting element 83.

FIG. 8E shows the support 40 in the second position. This position differs from the position from FIG. 8D in that the support 40 has undergone a translation in the direction of the pivot point 42. In order to make this possible, the support is provided with a slotted hole 88.

As a result of the translation, the contact element 4 of the lamp 2 bears against the contact member 83 of the greenhouse lighting fitting, thus electrically connecting the lamp 2. It is possible to choose a spring 85 of such stiffness that it effects the translation to the second position, but the translation may also be effected manually.

The translation may also result in the support 40 coming to bear against the bracket 31 for the reflector 30. Consequently, the greenhouse lighting fitting blocks less incident sunlight.

It will be clear to those skilled in the art, that when the support 40 is moved from the second position to the first position, the abovementioned steps are carried out in reverse order and in the opposite direction.

In FIG. 8, a rotating movement is used while moving the support 40 from its first position in the direction of its second position. However, alternatively, it is also possible to use a translation.

In a third embodiment (not shown), the support 40 is detachable from the fitting body. With an embodiment of this type, the lamp 2 may be premounted in the support 40, for example by a fitter on a work bench. This has the advantage that fitting the lamp in or on the support 40 does not have to take place at an elevated level. During preassembly, the lamp 2 is positioned relative to the support 40.

In this embodiment, once the lamp 2 has been premounted in the support 40, the support 40 is connected to the fitting body. To this end, the support is moved to a first position relative to the fitting body. By moving the support 40 into this first position, the lamp 2 is at the same time also correctly positioned relative to the fitting body.

Then, the support 40 is moved to a second position relative to the fitting body, which position causes the lamp which rests on and is correctly positioned by the support to be mechanically secured relative to the fitting body.

FIG. 9 shows a further alternative embodiment of a greenhouse lighting fitting according to the invention. In this embodiment as well, precautions have been taken to eliminate the danger of inadvertently touching the electrical contact member of the fitting. FIG. 9 shows this alternative embodiment in the open position.

FIG. 10 shows an enlarged detail A of FIG. 9. The lamp 2 is in this embodiment securely clamped to the support 40 by means of leaf springs 90 which together form the retaining means 70. In this example, the leaf springs 90 engage on the H-shaped pinches 5 of the lamp 2.

The contact element 4 of the lamp 2 rests on the carrier element 91. This carrier element 91 supports the contact element 4 at least at the ends. Raised portions 92 of the carrier element 91 secure the contact element 4 in the transverse direction. The raised portions are interrupted at the location of the central section of the contact element 4 of the lamp 2.

FIG. 11 shows, enlarged and in cross section, the connecting assembly 93 from the embodiment of FIG. 9. This is the part of the fitting body which ensures the electrical connection.

In this embodiment, the connecting assembly comprises a contact member 50 which is pushed against the guard 96 by means of a spring 94. Guard 96 protects the contact member, except at the location of the recess 95. In addition, the guard 96 has two projections 97 which further protect the exposed part 50* of the connecting member 50.

When the support 40 is in the second position, the contact element 4 of the lamp 2 is situated in the recess 95 and bears against the contact member 50. This is diagrammatically indicated in FIG. 11 by 4*.

In this embodiment, the surface of the exposed part 50* of contact member 50 is limited in size and it is furthermore situated deep inside the structure of the fitting body. This virtually completely eliminates the risk of the exposed part 50* of the contact member 50 being inadvertently touched. An advantage of this embodiment is that the guard of the contact member 50 is constructed without moving parts.

FIG. 12 shows an example of a greenhouse lighting fitting according to the second aspect of the invention. The greenhouse lighting fitting has a lamp holder and a reflector 31. The reflector 31 is connected by means of a bracket 30 to a housing 10, in which a lamp gear 109 for operating a lamp arranged in the greenhouse lighting fitting is fitted. The reflector 31, lamp holder, housing 10 and the lamp gear 109 in this example form part of the fitting body.

A connecting unit 35 for producing an electrical connection with the greenhouse lighting fitting is coupled to the housing 10. This connecting unit 35 forms part of a preassembly unit 101. This preassembly unit 101 is connected to a fastening element 20 for mechanically fastening the greenhouse lighting fitting to a bearing structure 3 arranged in the greenhouse. In this example, the fastening element 20 has two hooks 36 which grip around the bearing structure 3. The two hooks 36 are connected to one another by a strip 37, which is connected to the preassembly unit 101.

Attached to the bearing structure 3 is a power supply cable 110. A tapping of this power supply cable 110 is in this example guided into the preassembly unit 101 via a union nut 102. Inside this preassembly unit 101, the power supply cable 110 is connected to the connecting unit 35. The power supply cable 110 is electrically connected to an external power source, such as the mains, as a result of which the greenhouse lighting fitting is thus connected to this external power source via the connecting unit 35.

FIG. 13 shows two further variants of the connection of the connecting unit 35 to the power supply cable 110 in a greenhouse lighting fitting according to the second aspect of the invention. In the variant of FIG. 13a, the end of a tapping of the power supply cable 110 is provided with a first plug 111. This plug fits a first female socket 103 which is provided on the preassembly unit 101. Of course, it is also possible for the preassembly unit 101 to be provided with a plug and the power supply cable 110 with a female socket.

A combination of FIGS. 12 and 13a is likewise possible. In this case, the power supply cable 110 is guided into the preassembly unit 101 via a union nut 102, and the plug connection between the power supply cable 110 and the connecting unit 35 is produced inside the preassembly unit 101.

FIG. 13b shows a further variant of the connection of the connecting unit 35 to the power supply cable 110. In this example, the power supply cable 110 is provided with a splitter having a first plug 111. This plug 111 fits a second female socket 116 which is arranged on the first end of an intermediate cable 115. The second end of this intermediate cable 115 is provided with a second plug 117 which fits the first female socket 103 of the preassembly unit 101. Varying the length of the intermediate cable 115 offers significant flexibility regarding the possible position of the greenhouse lighting fitting in the greenhouse.

FIG. 14 shows a cross section of a part of a greenhouse lighting fitting according to the second aspect of the invention. As can be seen in FIG. 14, the power supply cable 110 is connected to the connecting unit 35 via a plug connection between the first plug 111 and the first female socket 103. The connecting unit 35 is connected to the lamp gear 109 via a first connector 104 in the preassembly unit 101 and a second connector 108 in the housing 10. The first and second connector 104, 108 together thus form the electrical connection of the lamp gear 109 to the connecting unit 35.

The preassembly unit 101 is connected to the strip of the fastening element 20 via mechanical fastening 105. The fitting body is connected to the preassembly unit 101 via mechanical connection 107. The fitting body is thus connected to the fastening element 20 via the preassembly unit 101.

The housing 10 and the preassembly unit 101 are for example designed for both parts to be pushed onto one another in the same direction as the insertion direction for connecting the connectors 104, 108 to one another. For this purpose, the housing 10 and the preassembly unit 101 are for example provided with one or more pairs of ribs or grooves or the like which mate in a positive-locking manner, preferably in such a manner that when the components have been pushed onto one another, the fitting body can no longer fall down. This is shown diagrammatically in FIG. 14a. This sliding connection can be secured using a locking facility.

In practice, it has been found to be advantageous if the sliding connection is achieved by means of a wedge-shaped groove into which a bearing element having a corresponding wedge shape can be pushed. The wedge-shaped groove is for example provided in the preassembly unit, and the bearing element on the housing. In this manner, a strong connection is obtained, in which the play between the preassembly unit and the housing is minimized.

In an advantageous embodiment, the locking is effected by a rotatable element in the shape of a semi-round disc. This disc can be rotated about a shaft which extends in the direction of the sliding movement for installation or removal. The position of the disc relative to the preassembly unit and the housing can either enable or disable installation or removal.

FIG. 15 shows an example of a method for fastening a greenhouse lighting fitting according to the second aspect of the invention in a greenhouse.

With the method according to FIG. 15, a bearing structure 3 is arranged in the greenhouse. In this example, this bearing structure 3 has horizontal girders from a C-section, in which power supply cables 110 are arranged.

The end of a tapping of such a power supply cable 110 is provided with a terminal. In this example, the terminal is in the shape of a first plug 111, which is arranged on the end of the respective tapping of the power supply cable 110.

The connecting unit 35 is then connected to the terminal, in this case by connecting the first plug 111 to the first female socket 103. This is shown in FIG. 15b.

Subsequently, the fitting body is electrically and mechanically connected to the preassembly unit 101. This is shown in FIG. 15c.

In the example shown, the preassembly unit 101 is provided with a selection means for selecting the phase of the power with which a lamp to be fitted in the greenhouse lighting fitting will be operated. The preassembly unit 101 is provided with an indicator 112 which indicates which phase has been selected.

Subsequently, the preassembly unit 101 of the greenhouse lighting fitting is fastened to the bearing structure 3. This is shown in FIG. 15c.

In the illustrated examples of the greenhouse lighting fittings according to both aspects of the invention, the greenhouse lighting fitting 1 comprises a support 30 which extends over at least part of the circumference of the reflector 31 and to which the reflector 31 is attached. In this example, the support 30 is designed as a bracket. This bracket provides additional stiffness for the reflector 31. Consequently, the reflector 31 can be made from relatively thin (and therefore easily deformable) material. Moreover, the reflector 31 also maintains its shape better over the course of time.

In order to facilitate installation, it is advantageous if the reflector 31 can be connected to the support 30 by means of a clamp-fit connection. This can be achieved by arranging one or more suitable clamps between the support 30 and the reflector 31.

1. Greenhouse lighting fitting, in particular suitable for use in combination with an assimilation lamp to be fitted in the greenhouse lighting fitting, which greenhouse lighting fitting has a fitting body which comprises:
a fastening element for mechanically fastening the greenhouse lighting fitting to a bearing structure,
a reflector for directing the light emanating from a lamp to be fitted in the greenhouse lighting fitting downwards, and
a contact member for making an electrical connection with the lamp to be fitted in the greenhouse lighting fitting,
wherein the greenhouse lighting fitting furthermore comprises a support for bearing the lamp to be fitted, which support is provided with a primary positioning element for positioning the lamp to be borne by the support relative to the greenhouse lighting fitting, and which support is moveable relative to the fitting body between a first position, in which a lamp to be fitted in the greenhouse lighting fitting can be placed on the support, and a second position, in which the position of the support relative to the fitting body ensures that the lamp resting on and positioned by the support is mechanically secured relative to the fitting body.

2. Greenhouse lighting fitting according to claim 1, in which the contact member bears against a contact element of the lamp under a suitable contact pressure in the second position of the support in order to produce the electrical connection with the lamp.

3. Greenhouse lighting fitting according to claim 1, in which the fitting body comprises a first spring element, which is designed to mechanically secure a lamp resting on the support with respect to the fitting body when the support is in its second position.

4. Greenhouse lighting fitting according to claim 1, in which the support comprises a second spring element, which is designed to mechanically secure a lamp resting on the support with respect to the fitting body when the support is in its second position.

5. Greenhouse lighting fitting according to claim 1, in which the first spring element is designed to push the fitted lamp against the primary positioning element in the second position of the support.

6. Greenhouse lighting fitting according to claim 2, in which at least one spring element is a leaf spring.

7. Greenhouse lighting fitting according to claim 2, in which at least one spring element engages directly on the fitted lamp in the second position of the support.

8. Greenhouse lighting fitting according to claim 1, in which the greenhouse lighting fitting has a third spring element in order to push the contact member against the contact element of a lamp resting on the support when the support is in its second position.

9. Greenhouse lighting fitting according to claim, in which the greenhouse lighting fitting has a third spring element in order to push the contact member against the contact element of a lamp resting on the support when the support is in its second position, and wherein the spring stiffness of the third spring element differs from the spring stiffness of the first spring element.

10. Greenhouse lighting fitting according to claim 4, in which the greenhouse lighting fitting has a third spring element in order to push the contact member against the contact element of a lamp resting on the support when the support is in its second position, and wherein the spring stiffness of the third spring element differs from the spring stiffness of the second spring element.

11. Greenhouse lighting fitting according to claim 1, in which the support has a handle, with which the support can be moved from its first position into its second position and from its second position into its first position.

12. Greenhouse lighting fitting according to claim 1, in which the support has a pivot point, about which pivot point the support can swing relative to the fitting body.

13. Greenhouse lighting fitting according to claim 11, in which the support has a pivot point, about which pivot point the support can swing relative to the fitting body, and wherein the handle is situated further away from the pivot point than the primary positioning element.

14. Greenhouse lighting fitting according to claim 1, in which the support is fastened to the fitting body so as to be translatable.

15. Greenhouse lighting fitting according to claim 1, in which the fitting body comprises a secondary positioning element which is designed to cooperate, in the second position of the support, with the primary positioning element in order to position a lamp resting on the support relative to the fitting body.

16. Greenhouse lighting fitting according to claim 15, in which the secondary positioning element comprises the first and/or the third spring element.

17. Greenhouse lighting fitting according to claim 15, in which the primary positioning element is designed to position a lamp resting on the support in a first direction and the secondary positioning element is designed to position a lamp resting on the support in a second direction, which second direction is different from the first direction.

18. Greenhouse lighting fitting according to claim 1, in which the support comprises a bracket, on which the primary positioning element is arranged.

19. Greenhouse lighting fitting according to claim 1, in which the support is downwardly directed in its first position.

20. Greenhouse lighting fitting according to claim 1, in which the support is substantially horizontal in its second position.

21. Greenhouse lighting fitting according to claim 1, in which the primary positioning element comprises two positioning elements arranged at a distance from one another, each of which is designed to engage on a lamp resting on the support.

22. Greenhouse lighting fitting according to claim 1, which greenhouse lighting fitting is suitable for use in combination with a double-ended lamp, which lamp is provided with a pinch in the glass on at least one of the two ends, the primary positioning element being designed to engage on this pinch.

23. Greenhouse lighting fitting according to claim 22, which greenhouse lighting fitting is suitable for use in combination with a double-ended lamp, the pinch of which has a substantially H-shaped cross section, the primary positioning element being in the shape of a block which fits into the pinch of the lamp.

24. Greenhouse lighting fitting according to claim 1, in which the support comprises a lock for locking the support in its second position.

25. Greenhouse lighting fitting according to claim 1, in which the fitting body also comprises a connecting assembly, which connecting assembly comprises:
a first connecting element on which the contact member is provided, and
a second connecting element for protecting the contact member when the support is in the first position,
the first and second connecting elements being movable relative to one another.

26. Greenhouse lighting fitting according to claim 25, in which means are provided for removing the guard from the contact member when the support is moved from the first position to the second position.

27. Greenhouse lighting fitting according to claim 26, in which the means for removing the guard from the contact member comprises a guiding member, which guiding member is connected to the support.

28. Greenhouse lighting fitting, in particular suitable for use in combination with an assimilation lamp to be fitted in the greenhouse lighting fitting, which greenhouse lighting fitting has a fitting body which comprises:
a fastening element for mechanically fastening the greenhouse lighting fitting to a bearing structure,
a reflector for directing the light emanating from a lamp to be fitted in the greenhouse lighting fitting downwards, and
a contact member for making an electrical connection with the lamp to be fitted in the greenhouse lighting fitting,
wherein the greenhouse lighting fitting furthermore comprises a support which is removable from the fitting body for bearing the lamp to be fitted, which support is provided with a primary positioning element for positioning the lamp to be borne by the support relative to the support, which support, once it has been connected to the greenhouse lighting fitting, has an operating position in which the position of the support relative to the fitting body ensures that the lamp which is borne and positioned by the support is mechanically secured relative to the fitting body.

29. Combination of an (assimilation) lamp and a greenhouse lighting fitting according to claim 1.

30. Greenhouse provided with at least one greenhouse lighting fitting according to claim 1.

31. Method for fitting a lamp in a greenhouse lighting fitting according to claim 1, which method successively comprises:
moving the support into its first position,
placing a lamp on the primary positioning element, the lamp being positioned relative to the greenhouse lighting fitting, and
moving the support into its second position, the lamp being secured relative to the fitting body.

32. Method for fitting a lamp in a greenhouse lighting fitting according to claim 31, which method successively comprises:
placing a lamp on the support in such a manner that the lamp is correctly positioned relative to the support,
connecting the support to the fitting body, and
moving the support into its operating position, in which the lamp is secured relative to the fitting body.

33. Fitting body for a greenhouse lighting fitting, in particular suitable for use in combination with an assimilation lamp to be fitted in the greenhouse lighting fitting, which fitting body comprises:
a fastening element for mechanically fastening the greenhouse lighting fitting to a bearing structure,
a reflector for directing the light emanating from a lamp to be fitted in the greenhouse lighting fitting downwards, and
a contact member for making an electrical connection with the lamp to be fitted in the greenhouse lighting fitting,
wherein the fitting body comprises connecting means for detachably connecting a support for positioning a lamp relative to the fitting body to the fitting body and securing the lamp relative to the fitting body.

34. Support suitable for use in combination with a fitting body according to claim 33, which support comprises:
connecting means for detachably connecting the support to the fitting body, and
a primary positioning element for positioning the lamp borne by the support relative to the support.

35. Greenhouse lighting fitting according to claim 1, in which the fitting body comprises a guard for protecting the contact member, which guard comprises a recess for at least partially accommodating the contact element when the support is in its second position.

36. Greenhouse lighting fitting which comprises:
a fitting body which comprises at least one lamp holder and one reflector,
a connecting unit for producing an electrical connection of the greenhouse lighting fitting,
a fastening element for mechanically fastening the greenhouse lighting fitting to a bearing structure provided in the greenhouse, and
a lamp gear for operating a lamp mounted in the greenhouse lighting fitting, which lamp gear can be electrically connected to the connecting unit,
wherein the greenhouse lighting fitting comprises a preassembly unit in which at least the connecting unit is arranged, which preassembly unit is detachable in its entirety from the associated fitting body of the greenhouse lighting fitting.

37. Greenhouse lighting fitting according to claim 36, in which the greenhouse lighting fitting furthermore comprises a selection means for selecting the phase of the electric power for supplying the lamp gear.

38. Greenhouse lighting fitting according to claim 37, in which the greenhouse lighting fitting comprises an indicator for indicating the phase which has been selected using the selection means.

39. Greenhouse lighting fitting according to claim 36, in which the preassembly unit has a plug and the fitting body has a female socket which is designed to mate with the plug of the preassembly unit and thus produce an electrical connection between the connecting unit and the lamp gear.

40. Greenhouse lighting fitting according to claim 36, in which the lamp gear is fitted in a housing and in which the assembly consisting of the housing and lamp gear forms part of the fitting body.

41. Greenhouse lighting fitting according to claim 36, in which the preassembly unit comprises a union nut for the purposes of the electrical connection.

42. Greenhouse lighting fitting according to claim 36, in which the connecting unit has a plug or female socket for producing the electrical connection.

43. Greenhouse lighting fitting according to claim 36, in which the preassembly unit has a first mechanical connecting unit and the fitting body has a second mechanical connecting element, in which the first and the second mechanical connecting element are designed in order together to produce a positive-locking mechanical connection between the preassembly unit and the fitting body.

44. Greenhouse lighting fitting according to claim 43, in which the mechanical connecting elements are wedge-shaped.

45. Greenhouse lighting fitting according to claim 36, in which the greenhouse lighting fitting also comprises a locking means for mechanically locking the fitting body relative to the preassembly unit.

46. Greenhouse lighting fitting according to claim 45, in which the locking means comprises a rotatable semi-round disc.

47. Method for fastening a greenhouse lighting fitting to a bearing structure in a greenhouse according to claim 36, which method comprises:
fitting a power supply cable and thereby providing an electrical connection point for producing an electrical connection of the greenhouse lighting fitting,
connecting the connecting unit to the electrical connection point without the fitting body being coupled to the preassembly unit,
electrically connecting the fitting body to the connecting unit, and
mechanically connecting the greenhouse lighting fitting to the bearing structure.

48. Method according to claim 47, in which the method furthermore comprises selecting the phase of the electrical connection.

49. Method according to claim 48, in which the phase is selected using a selection means which forms part of the connecting unit.

50. Method according to claim 47, in which the connection between the electrical connection point and the connecting unit is produced by means of a plug connection.

51. Method according to claim 47, in which the preassembly unit is mechanically secured relative to the bearing structure, following which the fitting body is mechanically secured relative to the preassembly unit.

52. Method according to claim 47, in which the preassembly unit and the fitting body is connectable to one another by a translatory motion.

53. Method according to claim 52, in which the translation in the horizontal plane takes place when the greenhouse lighting fitting is in the operating position.

54. Greenhouse provided with a greenhouse lighting fitting according to claim 36.
